(19) United States
(12) Patent Application Publication
(10) Pub. No.: US 2007/0051613 A1
(43) Pub. Date: Mar. 8, 2007

(54) Tap water purifier

(76) Inventor: Alexander Levin, Binyamina (IL)

Correspondence Address: Alexander Levin, 5A Shvil Hachalav St., Binyamina, 30500, IL

(21) Appl. No.: 11/220,197

(22) Filed: Sep. 6, 2005

(51) Int. Cl. B01D 3/00; B01D 5/00

(52) U.S. Cl. 202/160; 202/185.3; 202/200; 202/185.5; 202/185.6

(57) ABSTRACT

This invention proposes a domestic apparatus for water purification, which is based on evaporation-condensation principle and operates under atmospheric pressure. Evaporation process is performed in this apparatus by simple evaporation from the surface of hot tap water without boiling process. The purifier can be easily disassembled and cleaned from scaling.

### BACKGROUND OF THE INVENTION

This invention relates to the field of domestic apparatuses for water purification. It is known that quality of tap water in many countries doesn't satisfy householders. Tap water has usually relatively high concentration of mineral salts, organic substances and microorganisms. There are some ways to overcome this problem.

The first one is supply to the householders bottled spring water, however, this way is very expensive. In addition, bottled water can readily become contaminated by airborne bacteria and viruses during dispensing process by the introduction of ambient air drawn inside the bottle as the water is dispensed.

For this reason different type of tap water purifiers are widely presented in domestic application.

The main type of such purifiers is related to filtration devices. In the first period of a filter operation a significant part of contaminants of the tap water is held in the filter. However, in the process of contaminants' collection in the filter, its purifying ability is decreased.

The purification systems based on reverse osmosis are very expensive.

For all these reasons the domestic tap water purifiers are very attractive. These devices operates on the base of evaporation-condensation principle and include usually a boiler provided with an electrical heating element (the boiler generates a steam from tap water), a condenser for steam condensation, and a distilled water storage.

There are some the USA patents, which disclose different constructions of such devices (see for example U.S. Pat. Nos. 5,762,762, 5,536,375, 4,943,353, 4,805,692). However all these patents describe devices with boilers which operate under certain pressure with application of boiling process.

Such devices do not provide required safety, expensive and are not suitable for cleaning the scaling formed on the internal walls of their boilers.

In addition, several designs of these patents incorporate demisters for separation of droplets contained in the generated steam as the result of boiling process.

All these circumferences make these devices very expensive and cause difficulties in their maintenance.

### BRIEF SUMMARY OF THE INVENTION

This invention proposes a tap water purifier, which operates under atmospheric pressure. Evaporation process is performed in this device by simple evaporation from the surface of hot tap water without boiling process. It allows achieving several advantages:

1. It is possible to combine evaporation and condensation processes in one chamber, which operates at atmospheric pressure. It permits in turn to construct a safely purifier with sufficiently thin walls. Such construction can be cheap and of low weight.

2. Since the evaporation process occurs without boiling, it is not accompanied with mist formation and, therefore, a demister designed to prevent condensation of vapors with droplets of tap water is not needed.

3. It is possible to construct the purifier with two or more evaporation-condensation sub-units, when in the following sub-unit the heat of vapors' condensation is used for evaporation of an additional portion of tap water.

4. The purifier can be easily disassembled and cleaned from scaling. In addition, rate of scaling formation for evaporation without boiling will be significantly lower.

The proposed purifier comprises some main units.

A distillate container has the rectangular horizontal cross-section, this container is provided with bottom legs, which should be positioned on a table.

This distillate container is provided with a tap positioned on the lower section of its front wall; the tap serves for dispensing the distilled water.

In addition, the distillate container can be provided with a level gauge showing the level of distillate in this container. It is possible to install a small water pump on the outer surface of the distillate container; this water pump serves for dispensing the distillate to a consumer. The distillate container is covered by an upper metal horizontal partition, which is provided with one lateral slot at its left extreme section and with two smaller lateral slots at its right section.

These slots serve for circulation of the cooled air via the upper space of the distillate container and for introduction of the distillate into the distillate container.

Heating the tap water is performed by an electrical heater, which has a form of a flat coil and is positioned in a metal housing. In addition, there is a layer of thermal insulation situated below this flat coil in the metal housing (the flat coil can be separated from the layer of thermal insulation by an additional metal partition). The lower horizontal side of the housing is installed on the central section of the upper horizontal partition of the distillate container. In addition, the flat coil of the electrical heater can be joined with a metal sheet in order to provide heating with higher homogeneity.

An external housing of a unit, which is intended to perform evaporation of the tap water and following condensation of formed vapors, is installed on the upper edge of the distillate container; this external housing has a form of a rectangular box. An evaporation sub-unit itself is formed by combination of the front and back walls of the external housing, two vertical partitions situated perpendicularly to these front and back walls, and the upper wall of the housing of the electrical heater, which plays a role of the bottom.

The external housing is covered at the top with a cover. There is a certain gap between this cover and the upper edges of the aforementioned vertical partitions. This gap serves for removal of vapors obtained in the evaporation sub-unit to a condensation sub-unit, which is formed between one vertical partition and the lateral adjacent wall of the external housing, and introduction of heated air from the gap between the second vertical partition and the opposite lateral wall of the external housing into the internal vapors' space in this evaporation sub-unit.

The central area of the cover is provided with an inlet connection with a plug; it is applied for filling the evaporation sub-unit with the tap water. Additionally, the evaporation sub-unit can be connected with a water cock in order to perform delivery of tap water automatically from the water main, in this case the evaporation sub-unit is provided as well with a float valve.

The central section of the front wall of the external housing, which serves as well as the front wall of the evaporation sub-unit, is provided with a tap for removal of residues of the tap water with concentrated impurities, and with a level gauge showing the tap water level in the evaporation sub-unit.

A heat-exchanging plate with fins directed inwards is installed on the inner side of the right lateral wall of the external housing in the gap between this wall and the right vertical partition. Another finned heat-exchanging plate is F installed on the outer side of this wall adjacently to the first heat-exchanging plate. In addition, a fan (or a set of fans) serves for blow of the surrounding air through the fins of the outer heat-exchanging plate.

The aforementioned upper horizontal partition of the distillate container is provided with a flanging and an opening; this section of the horizontal partition is located beneath the inner heat-exchanging plate; in such a way this section of the upper horizontal partition forms a tray. The opening in this tray serves for installation of a filter for performance additional purification of the distillate mainly from chlorine and organic volatile impurities. In addition, this filter can contain minerals with low solubility in water for improvement of taste of the distillate.

The upper cover of the external housing can be supplied with an opening and a plug, this opening is intended for installation of a small bottle with minerals' solution, this solution added to the distillate during a certain period and serves for improvement of its taste.

The outer side of the left partition is provided in turn with an additional heat-exchanging plate with fins directed inward the gap between the left vertical partition and the left lateral wall of the external housing.

The described water purifier operates in the following manner:

The power of the electrical heater is chosen is such a way, that specific heat flux transferred via the horizontal cross-section of the evaporation sub-unit does not exceed a specific value (about of 5 W/cm²). For such low value of heat flux, the tap water is evaporating in the evaporation sub-unit without boiling process. It obviates the need of a demister application.

The hot water vapors with the air contained in the evaporation sub-unit are moving to the fins of the cooled inner heat-exchanging plate. After vapors' condensation on these fins and accompanied cooling the air, this air is descending via the right slots in the upper horizontal partition of the distillate container into its inner space. Then the air is ascending via the slot in the left lateral section of the upper horizontal partition into the gap between the left lateral wall of the external housing and the left vertical partition.

The left heat-exchanging plate, which is transferring heat from the external wall of the evaporation sub-unit into the gap between this wall, heats the air in this gap. Thereafter the heated air enters into the upper space of the evaporation sub-unit and it is mixed with new portions of vapors of the tap water before its passing to the inner cooling heat-exchanging plate.

In order to intensify air circulation in the circle described above, it is possible to apply (additionally or instead of the left finned heat-exchanging plate) a fan, which is positioned in the gap between the left vertical partition and the left lateral wall of the external housing.

In another version of the purifier, the left vertical partition, the left slot in the upper horizontal partition and the left heat-exchanging plate are not used and there is a relatively big distance between the upper edge of the right vertical partition and the cover. Such distance allows locating the inner and outer heat-exchanging plates on the right wall of the external housing at the level of the gap between the upper edge of the right vertical partition and the cover. This design ensures as well removal of cold air from the fins of the inner heat-exchanging plate.

The upper wall of the housing of the electrical heater can be provided with the vertical fins in order to increase the heat-exchanging surface in the evaporation chamber and to prevent boiling of the tap water.

### BRIEF DESCRIPTION OF SEVERAL VIEWS THE DRAWINGS

Preferred embodiments of the invention are described below by way of example with reference to the accompanying drawings, in which:

FIG. 1 is a middle cross-sectioned view of a purifier in parallel to its front plan;

FIG. 2 is a cross-sectional view of the purifier taken on line A-A perpendicularly to the front plan;

FIG. 3 is a cross-sectional view of the purifier taken on line B-B perpendicularly to the front plan;

FIG. 4 is a cross-sectional view of the purifier taken on line C-C in parallel to the horizontal plane;

FIG. 5 is a middle cross-sectional view of a purifier in parallel to its front plan, when the condensation unit of this purifier is arranged on the lateral wall of the distillate container.

FIG. 6 is a top view of an electrical heater.

### DETAILED DESCRIPTION OF THE INVENTION

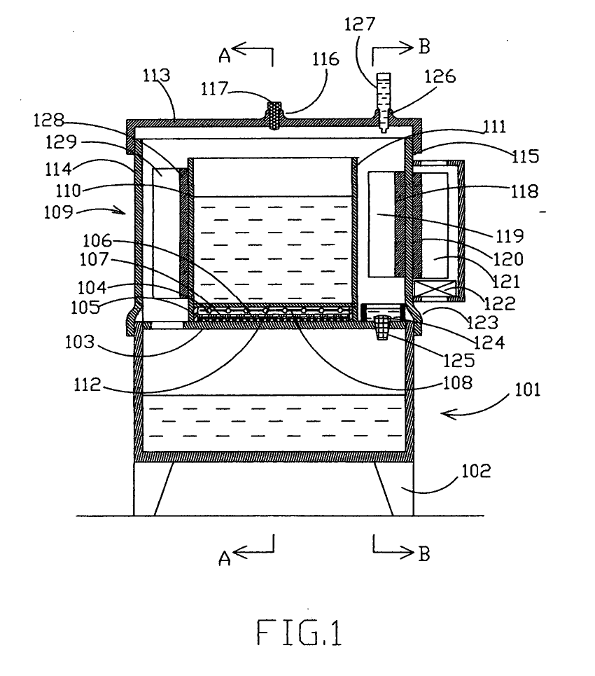

FIG. 1 is the middle cross-sectional view of a tap water purifier in parallel to its front plan.

It comprises a distillate container 101 which has the rectangular horizontal cross-section, this container is provided with bottom legs 102, which should be positioned on a table.

Container 101 is covered by an upper metal horizontal partition 103, which is provided with one lateral slot at its left extreme section and with two smaller slots at its right section. These slots serve for circulation of cooled air via the upper space of the distillate container.

An electrical heater 104 in the form of a flat coil is positioned in a metal housing 105. In addition, there is layer 106 of thermal insulation situated below this flat coil in the metal housing 105 (the flat coil is separated from the layer of thermal insulation by an additional metal partition 107). The lower horizontal side of the metal housing 105 is installed on the central section of the upper horizontal partition 103 of the distillate container. In addition, the coil of the electrical heater 104 is joined with a metal sheet 108 in order to provide heating with higher homogeneity.

An external housing 109 of evaporation and condensation sub-units is installed on the upper edge of the distillate container 101; this external housing has a form of a rectangular box. The evaporation sub-unit itself is formed by combination of the front and back walls of the external housing, two vertical partitions 110 and 111 situated perpendicularly to these front and back walls, and the upper wall 112 of the metal housing 105 of the electrical heater 104.

The external housing 109 is covered at the top with cover 113. There is a certain gap between this cover and the upper edges of the aforementioned vertical partitions 110 and 111.

This gap serves for removal of vapors obtained in the evaporation sub-unit to the condensation sub-unit, which is formed between the first vertical partition 110 and the lateral adjacent wall 114 of the external housing 109, and introduction of heated air from the gap between the second vertical partition 111 and the opposite lateral wall 115 of the external housing into the internal vapors' space in this evaporation sub-unit.

The central area of the cover 113 is provided with an inlet connection 116 with plug 117; they are applied for filling the evaporation unit with the tap water.

A heat-exchanging plate 118 with fins 119 directed inwards is installed on inner side of the right lateral wall 115 of the external housing in the gap between this wall and the right vertical partition 111. Another heat-exchanging plate 120 with fins 121 is installed on the outer side of this wall adjacently to the first heat-exchanging plate. In addition, fan 122 (or a set of fans) serves for blow of surrounding air through fins 121 of the outer heat-exchanging plate 120. The aforementioned upper horizontal partition 103 of the distillate container is provided with flanging 123 and opening 124; this section of the horizontal partition is located beneath the inner heat-exchanging plate 118 and its fins 119; in such a way this section of the upper horizontal partition forms a tray. Opening 124 in this tray serves for installation of filter 125 for performance additional purification of the distillate mainly from chlorine and organic volatile impurities. In addition, this filter can contain some mineral substances; these substances are dissolving slowly in distillate and improve its taste.

The upper cover 113 of the external housing can be supplied with opening 126 which serves for installation a small bottle 127 with minerals' solution, this solution is added to the distillate during a certain period and serves for improvement of its taste.

The outer side of the left partition 110 is provided with an additional heat exchanging plate 128 with tins 129 directed inward the gap between the left vertical partition 110 and the left lateral wall 115 of the external housing 109.

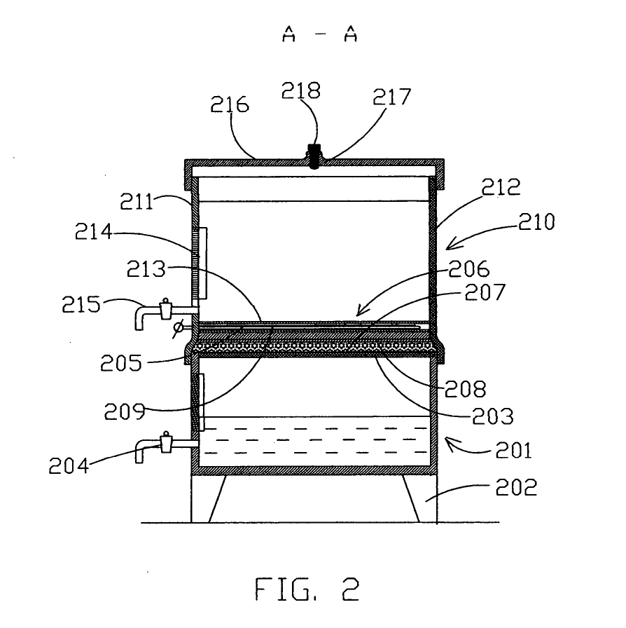

FIG. 2 presents a cross-sectional view of the purifier shown in FIG. 1, this cross-sectional view is taken on line A-A perpendicularly to the front plan.

The cross-sectional view comprises a distillate container 201 with bottom legs 202 and an upper horizontal partition 203. The front wall of the distillate container 201 is provided at its lower section with tap 204 for dispensing the distillate. An electrical heater 205 in the form of a flat coil is positioned in a metal housing 206. In addition, there is layer 207 of thermal insulation situated below this flat coil in the metal housing 206 (the flat coil is separated from layer 207 of the thermal insulation by an additional metal partition 208).

The lower horizontal side of the metal housing 206 is installed on the central section of the upper horizontal partition 203 of the distillate container. In addition, the coil of the electrical heater 205 is joined with a metal sheet 209 in order to provide heating with higher homogeneity.

An external housing 210 of evaporation and condensation sub-units is installed on the upper edge of the distillate container 201, this external housing has a form of a rectangular box. The cross-sectional view A-A shows front and back walls 211 and 212, and bottom 213 of the evaporation sub-unit, which plays at the same time a role of the upper wall of the housing of the electrical heater 205.

The front wall 211 is provided with a level gauge 214 and tap 215, which serves for discharging the tap water with concentrated impurities. The external housing 210 is covered at the top with cover 216. The central area of cover 216 is provided with an inlet connection 217 and plug 218; they are applied for filling the evaporation sub-unit with the tap water.

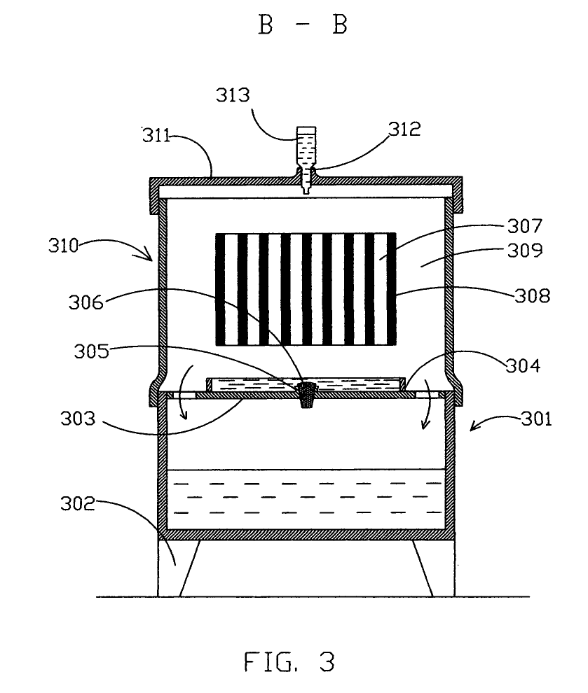

FIG. 3 shows a cross-sectional view of the purifier taken on line B-B perpendicularly to the front plan (see FIG. 1). It comprises a distillate container 301 with bottom legs 302 and an upper horizontal partition 303 with flanging 304. The central area of this section of the upper horizontal partition 303 is provided with opening 305 and a detachable filter 306. In addition, this detachable filter can contain minerals with low solubility in water in order to improve taste of the distillated water.

A heat-exchanging inner plate 307 with fins 308 is installed on a lateral wall 309 of a condensation sub-unit 310. The condensation sub-unit 310 is covered from aloft by cover 311, which is common for the whole external housing; the section of cover 311, which is related to the condensation sub-unit, is provided with opening 312 serving for installation a small bottle 313 with minerals' solution, this solution is added to the distillate during a certain period and improves its taste.

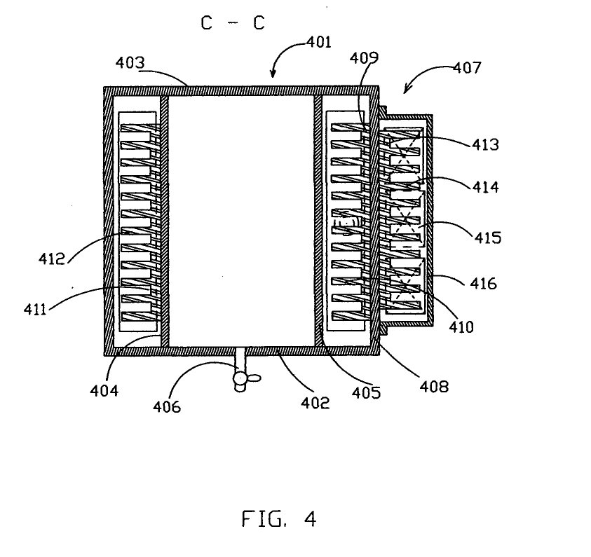

FIG. 4 shows a cross-sectional view of the purifier taken on line C-C in parallel to the horizontal plane (see FIG. 1). It comprises an evaporation sub-unit 401 formed by the central sections of front and back walls 402 and 403, and by left and right vertical partitions 404 and 405. A dispensing tap 406 is installed at the lower section of the front wall 402 forming this evaporation sub-unit.

A condensation sub-unit 407 is formed by extreme right sections of the front and back walls 402 and 403, the vertical right partition 405 and a right lateral wall 408 of the external housing. A heat-exchanging plate 411 with fins 412 is installed on the external side of the vertical left partition 404. An inner heat-exchanging plate 409 with fins 410 is installed on the internal side of the right lateral wall 408. An external heat-exchanging plate 413 with fins 414 is installed on the external side of the right lateral wall 408. In addition, some fans 415 are installed beneath the external heat-exchanging plate 413.

The whole outer construction (the external heat-exchanging plate 413 and fans 415) is covered by casing 416, which is provided with upper and lower slots.

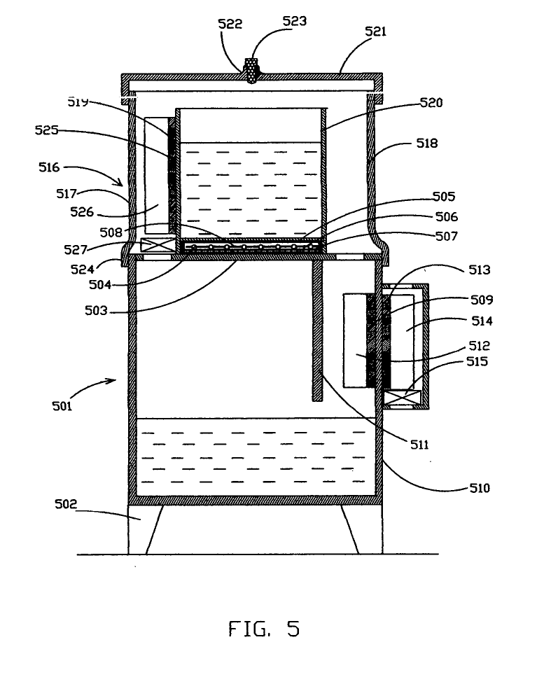

FIG. 5 is the middle cross-sectional view of a purifier in parallel to its front plan, when its condensation sub-unit is arranged on the lateral wall of a distillate container.

It comprises a distillate container 501, which has the rectangular horizontal cross-section; this distillate container is provided with bottom legs 502, which should be positioned on a table. The distillate container 501 is covered by an upper metal horizontal partition 503, which is provided with one lateral slot at its left extreme section and with a lateral slot at its right extreme section. These slots serve for circulation of cooled air via the upper space of the distillate container 501.

An electrical heater 504 in the form of a flat coil is positioned in a metal housing 505. In addition, there is layer 506 of thermal insulation situated below this flat coil in the metal housing 505 (the flat coil is separated from the layer of thermal insulation by an additional metal horizontal partition 507). The lower horizontal side of the metal housing is installed on the central section of the upper metal horizontal partition 503 of the distillate container.

The coil of the electrical heater 504 is joined with a metal sheet 508 in order to provide heating with higher homogeneity.

An inner heat-exchanging plate 509 of a condensation sub-unit is installed on the right lateral wall 510 of the distillate container. In addition, there is a vertical partition 511, which is installed on the upper metal horizontal partition 503 in order to ensure complete condensation of vapors on fins 512 of the inner heat-exchanging plate 509.

An outer heat-exchanging plate 513 with fins 514 is installed on the outer side of this lateral wall adjacently to the inner heat-exchanging plate. In addition, fan 515 or a set of fans serves for blow of the surrounding air through fins 514 of the outer heat-exchanging plate 513.

An evaporation sub-unit of the purifier comprises an external housing 516 with the lateral left and right walls 517 and 518 (front and back walls are not shown), and the left and right vertical partitions 519 and 520. Cover 521 is provided with an inlet connection 522 and plug 523, which serve for filling the evaporation sub-unit with the tap water. This evaporation sub-unit is installed on the upper edge of the distillate container by flanging 524.

The outer side of the left partition 519 is provided with an additional heat-exchanging plate 525 with fins 526 directed inward the gap between the left vertical partition 519 and the left lateral wall 517 of the external housing 516. In addition, there is fan 527 (or fans) installed in the lower section of the gap between the left vertical partition 519 and the left lateral wall 517.

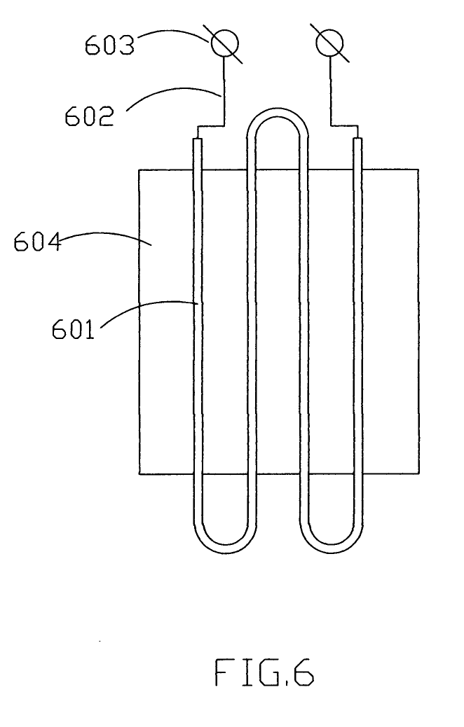

FIG. 6 is the front view of an electrical heater. It comprises an electrical flat heating coil 601, electrical wires 602 with terminals 603, and a metal sheet 604 which is joined with good thermal contact with the electrical flat heating coil 601.

What is claimed is:

1. A tap water purifier consisting of:
a distillate container, said distillate container is provided with: bottom legs; a tap for distillate dispensing; an upper horizontal partition provided with slots which serve for introduction of the distillate from above into said distillate container and, additionally, for air circulation through the upper space of said distillate container;
a tap water evaporation-condensation unit comprises: an electrical heater, which has a form of a flat coil and it is positioned in a metal housing, in addition, there is a layer of thermal insulation situated below said flat coil in said metal housing (said flat coil can be separated from the layer of said thermal insulation by an additional metal partition); the lower horizontal side of said metal housing is installed on the central section of said upper horizontal partition of said distillate container; said flat coil of said electrical heater is joined with a metal sheet in order to provide heating with higher homogeneity; an external housing of said evaporation-condensation unit is installed on the upper edge of said distillate container, said external housing has a form of a rectangular box; an evaporation sub-unit itself is formed by combination of the front and back walls of said external housing, two vertical partitions situated perpendicularly to said front and back walls, and said upper wall of said metal housing of said electrical heater; said external housing is covered at the top with a cover; there is a certain gap between said cover and the upper edges of said vertical partitions, said gap serves for removal of vapors generated in said evaporation sub-unit to a condensation sub-unit, which is formed between said right vertical partition and a lateral adjacent wall of said external housing, and introduction of heated air from the gap between said left vertical partition and a left lateral wall of said external housing into the internal vapors' space in said evaporation sub-unit;
said cover is provided with an inlet connection and a plug, they are applied for filling said evaporation sub-unit with the tap water;
a tap for removal of residues of the tap water with concentrated impurities, said tap is installed on the central section of said front wall of said external housing;
a level gauge showing the tap water level in said evaporation sub-unit; said level gauge is installed on the central section of said front wall of said external housing;
a first inner heat-exchanging plate with fins directed inwards; said first heat-exchanging plate is installed on the inner side of a right lateral wall of said external housing in the gap between said right lateral wall and said right vertical partition;
an outer finned heat-exchanging plate; said outer heat-exchanging plate is installed on the outer side of said right lateral wall adjacently to said first inner heat-exchanging plate;
a fan (or a set of fans); said fan is installed adjacently to said fins of said outer heat-exchanging plate and serves for blowing the surrounding air through said fins of said outer heat-exchanging plate;
a flanging of the section of said horizontal partition of said distillate container, said flanging is situated in said gap between said right lateral partition and said right lateral wall; in addition, said section of said upper horizontal partition is provided with slots and an opening; said flanging is located beneath said first heat-exchanging plate; in such a way, said section of said upper horizontal partition forms a tray; said opening in said tray serves for installation of a filter for performance additional purification of the distillate mainly from chlorine and organic volatile impurities;
an additional opening in said cover, said additional opening serves for installation a small bottle with minerals' solution, said minerals' solution is added to the distillate during a certain period and serves for improvement of its taste;
the outer side of said left partition is provided in turn with an additional inner heat-exchanging plate with fins directed inward the gap between said left vertical partition and said left lateral wall of said external housing.

2. A tap water purifier as claimed in claim 1, wherein the power of said electrical heater is chosen is such a way, that specific heat flux transferred via the horizontal cross-section said evaporation sub-unit is about of 5 W/cm² or less, for such low values of heat flux vapors of the tap water are forming in said evaporation sub-unit without boiling process.

3. A tap water purifier as claimed in claim 1, wherein in order to intensify air circulation there is a fan positioned in said gap between said left vertical partition and said left lateral wall of said external housing.

4. A tap water purifier as claimed in claim 4, wherein said left inner heat-exchanging plate is not applied.

5. A tap water purifier as claimed in claim 1, wherein the upper wall of said metal housing of said electrical heater is provided with vertical fins in order to increase the heat-exchanging surface of said evaporation sub-unit and prevent boiling of the tap water.

6. A tap water purifier as claimed in claim 1, wherein said left vertical partition, said left slot in said upper horizontal partition and said left heat-exchanging plate are not used, and there is a relatively big distance between the upper edge of said right vertical partition and said cover, such distance allows locating said inner and outer heat-exchanging plates on said right lateral wall of said external housing at the level of the gap between the upper edge of said right vertical partition and said cover.

6. A tap water purifier as claimed n claim 1, wherein said inner and outer heat-exchanging plates of said condensation sub-unit are arranged on the wall of said distillate container.

7. A tap water purifier as claimed in claim 1, wherein said evaporation sub-unit is provided with an automatic system of filling the tap water from a water cock up to a preset level.

8. A tap water purifier as claimed in claim 1, wherein said external housing is provided with an outer layer of thermal insulation.

9. A tap water purifier as claimed in claim 1, wherein a water pump is installed on the outer wall of said distillate container, said water pump serves for dispensing the distillate to a consumer.
